(19) United States
(12) Patent Application Publication
(10) Pub. No.: US 2004/0068427 A1
(43) Pub. Date: Apr. 8, 2004

(54) Four-dimensional resource allocation system

(76) Inventor: Timothy Feiya Su, Bellevue, WA (US)

Correspondence Address: TIMOTHY SU, 5715 138TH PL SE, BELLEVVE, WA, 98006, US

(21) Appl. No.: 10/065,341

(22) Filed: Oct. 7, 2002

(51) Int. Cl. G06F 17/60

(52) U.S. Cl. 705/9

(57) ABSTRACT

The present system is able to allocate resources to a system of tasks and calculate an optimum assignment plan with a set of user-adjustable criteria. In easier conditions, this is not difficult, but the problem becomes more complex when constraints are added. For example, choosing the best resource for a task when there are multiple variables to consider is not easy. This system uses a weighted average with user-defined scaling factors to decided the optimum condition of when and which resource to use. This allows each assignment plan to very closely match what the user has in mind.

### SUMMARY OF INVENTION

In any management role for a project or a company, there are several important issues that will make future work move along more efficiently at a lower cost. One of these is staff assignment. A few of the things that need to be taken into consideration are whether the person in question works well with others, is efficient and adept at the task given; has an hourly rate that will fit into any budget constraints, and whether his/her vacation time will cut into the project. This in itself is not an easy thing, but when more variables such as equipment and sites are added, staff assignment can become a nightmare.

Clearly, this is a field where computers would be helpful. However, a scan of the current project/staff assignment market shows that the largest products for project management, Microsoft Project and Primavera Project Planer (P3), only focus on the scheduling aspect, leaving staff assignments up to the user. In fact, almost all software focuses on scheduling and tracking.

However, project management theories tend to agree that picking the right people for the job is absolutely critical to success. As projects increase in scope and companies grow larger, staff allocation becomes harder and harder.

Therefore, it would be desirable to harness a computer″s natural accuracy and speed in performing many calculations to generate plans within seconds, saving project managers time and energy. Furthermore, it would be increasingly desirable if the program could adapt to fit users″ needs by allowing users to specify criteria for generating plans.

### BRIEF DESCRIPTION OF SEQUENCES

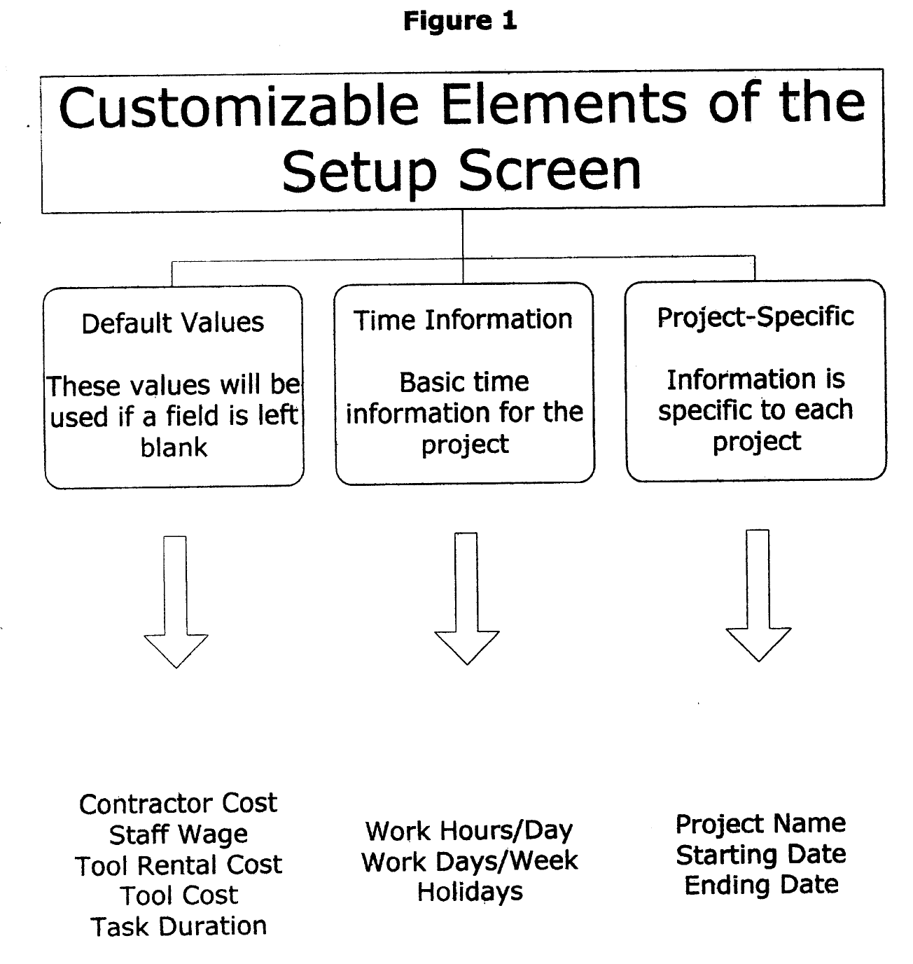

FIG. 1 is a screen shot of the setup screen

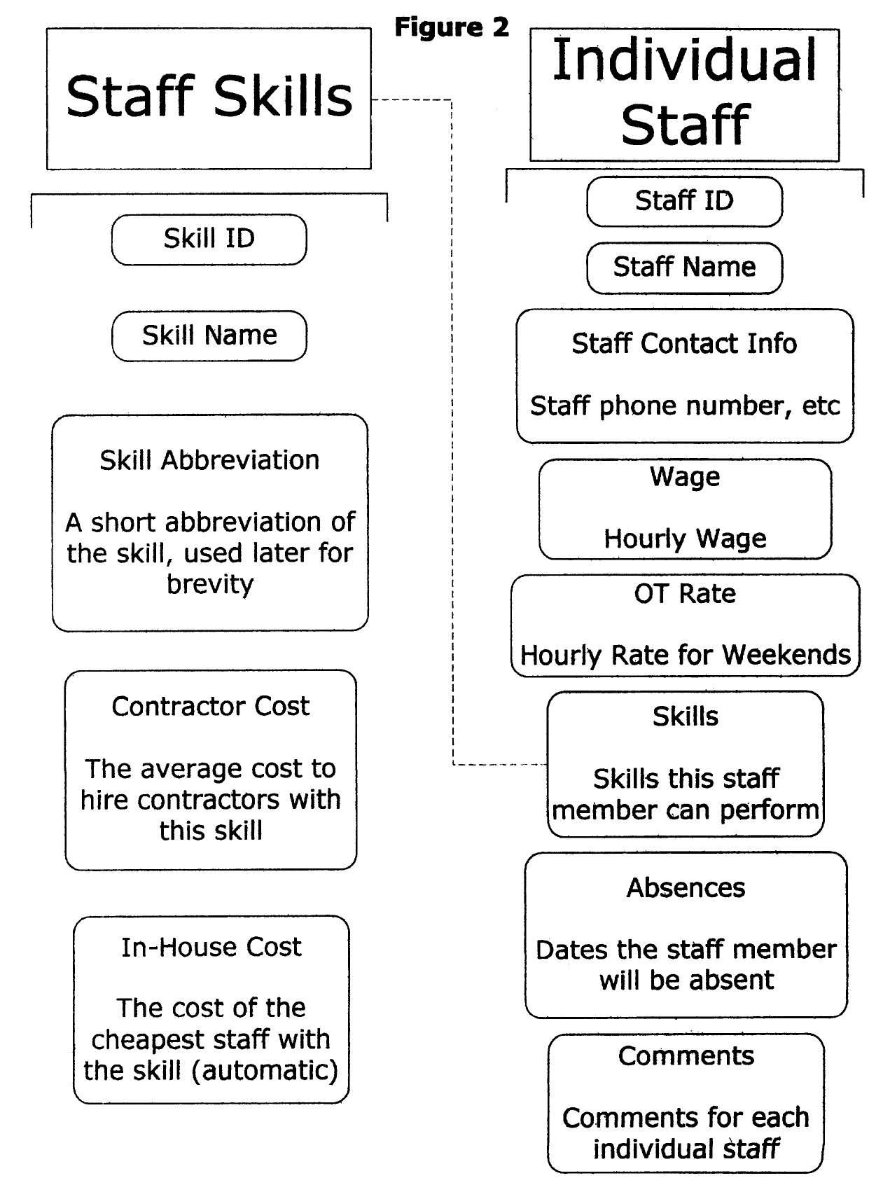

FIG. 2 is a screen shot of the skill editing screen

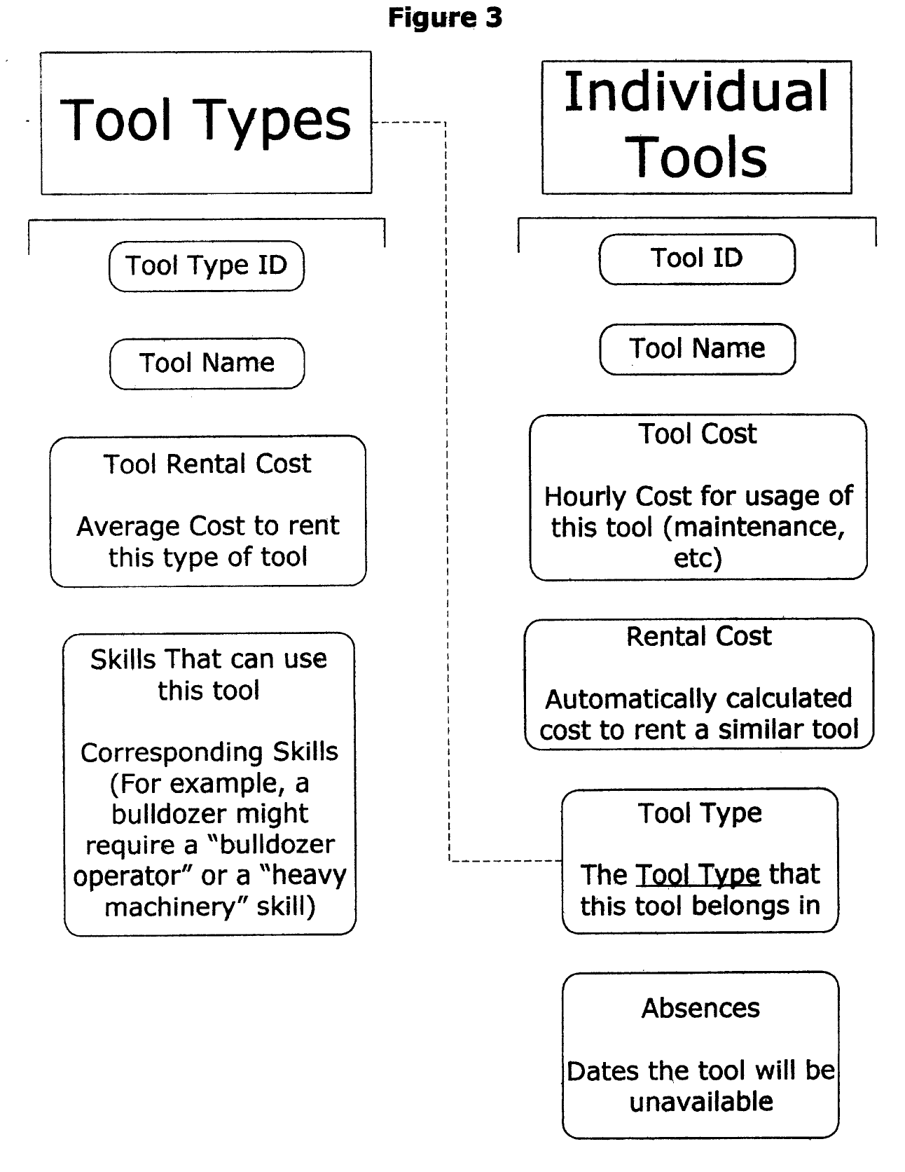

FIG. 3 is a screen shot of the individual staff screen

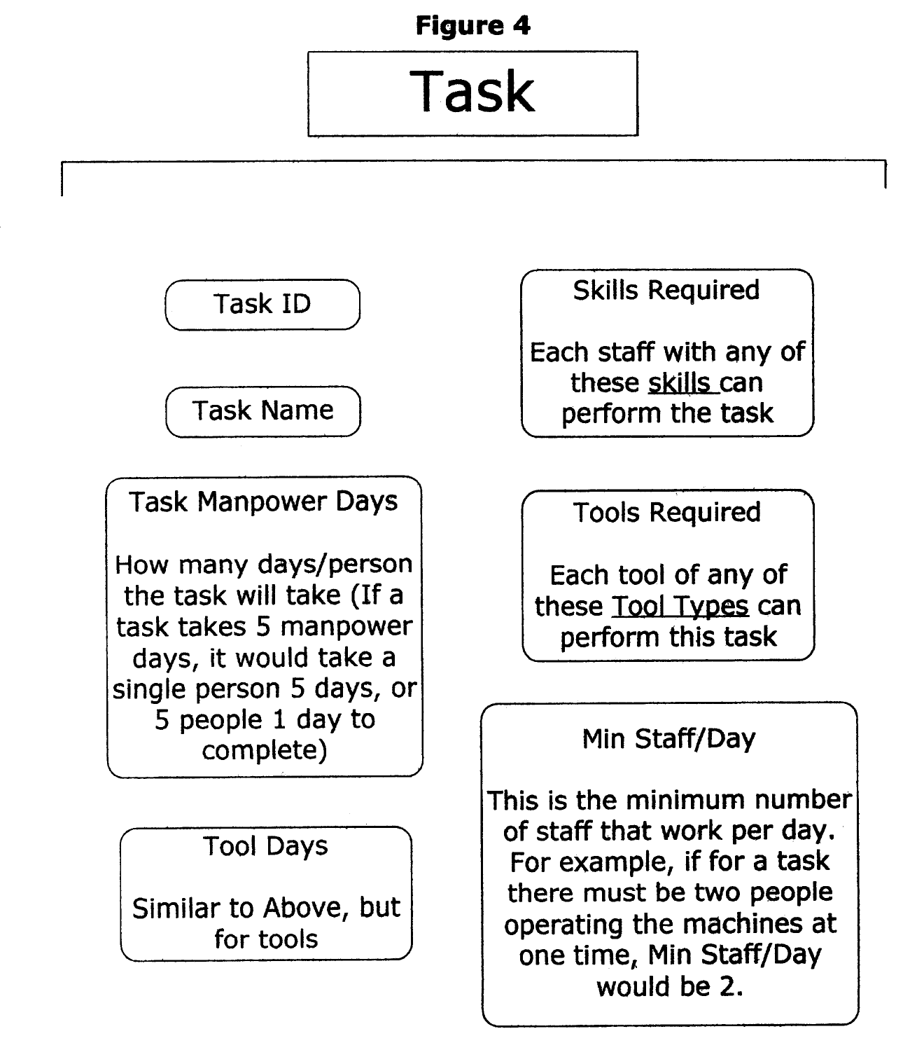

FIG. 4 is a screen shot of the tool type screen

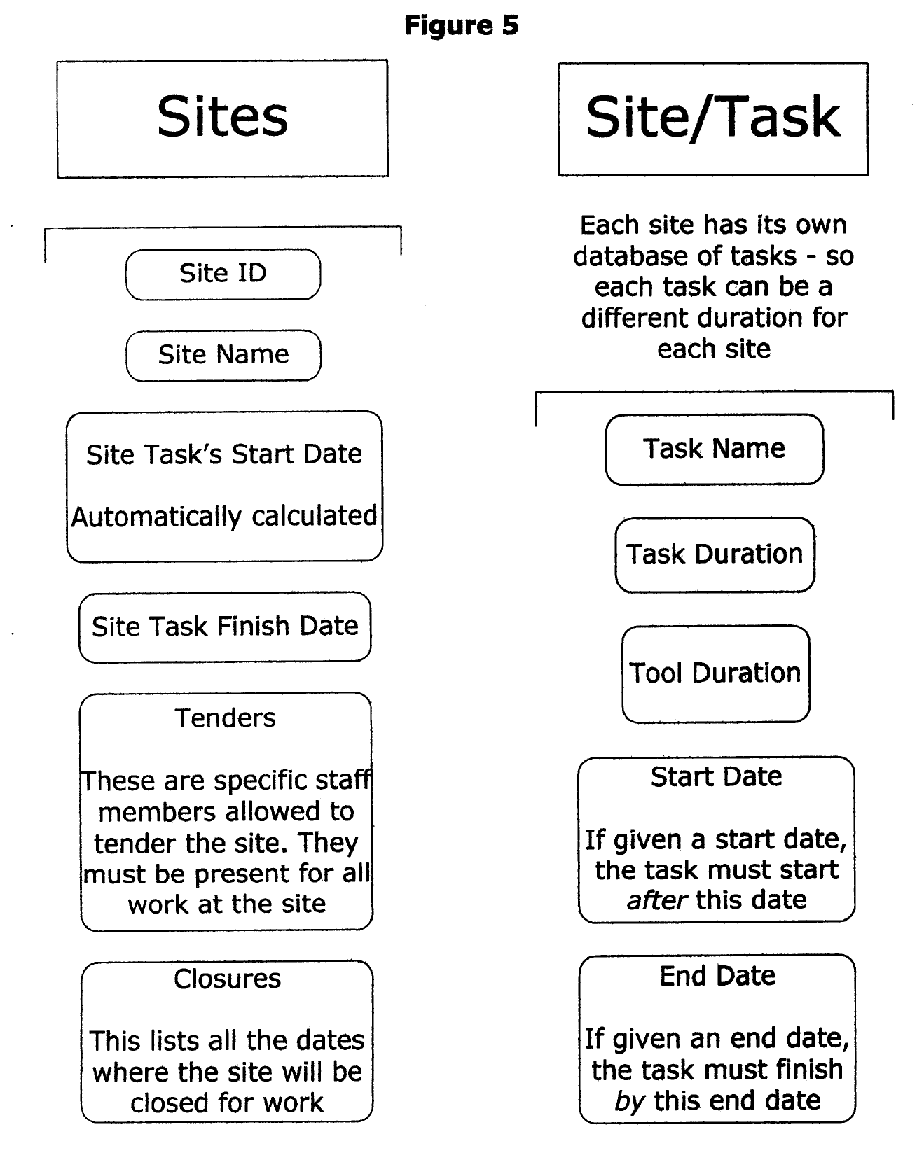

FIG. 5 is a screen shot of the individual tool screen

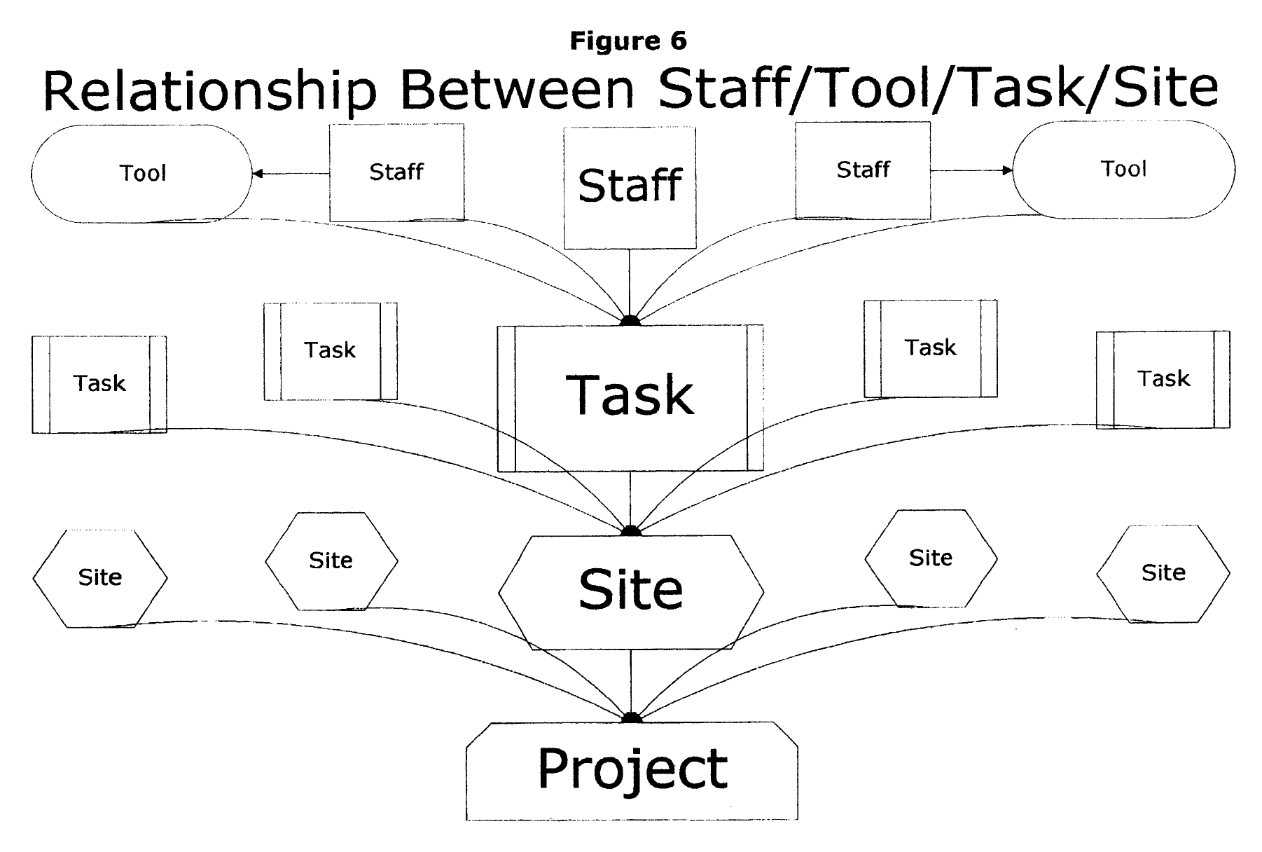

FIG. 6 is a screen shot of the task screen

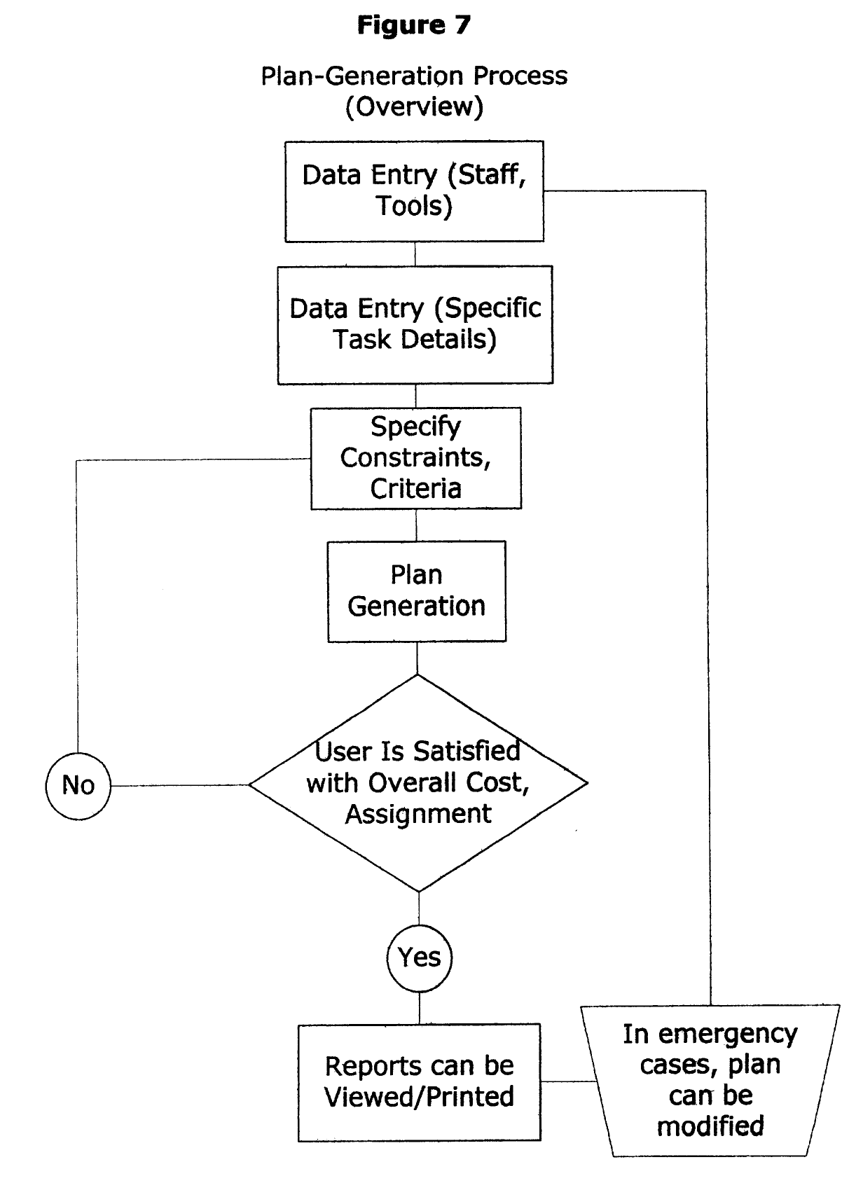

FIG. 7 is a screen shot of the site screen

FIG. 8 is a screen shot of the assignment panel

FIG. 9 is a screen shot of the modify panel

FIG. 10 is a view of a sample report exported to MS Project

FIG. 11 is a diagram detailing the relationships between the four dimensions

FIG. 12 is pseudo-code showing how the system selects the best staff

FIG. 13 shows how the class structure creates relationships and linkage

### DETAILED DESCRIPTION

### Field of Invention

The present invention relates to task and project management. More specifically, it relates to staff assignment and task management where tasks occur at one or more different locations (sites).

To assist in explaining how the system works and give a general feel for what it does, a basic overview of the system is given:

1) General Screen—This is where the user inputs basic information such as the name of the project, starting and ending dates, and holidays, workdays, and hours/day. This is used for both plan generation and cost estimates. (FIG. 1)

2) Base Data—Staff Skills—The user here defines skills that are available. These skills can be assigned to staff. Also, these skills are added to tasks to specify which staff can perform the task. (FIG. 2)

3) Base Data—Indiv. Staff—This is a list of individual staff. Users can enter information including hourly and overtime rates, staff off days, and skills. (FIG. 3)

4) Base Data—Tool Types—These are a list of general categories (e.g. “Bulldozer”). These are then assigned skills which can manage the equipment. For example, if a user created a skill called Bulldozer Operating and assigned it to the Bulldozer tool group, then only those workers with the Bulldozer Operating skill could use Bulldozers. (FIG. 4)

5) Base Data—Individual Tools—These are a list of specific tools that correspond to the tool categories defined under Tool Data. (FIG. 5)

6) Tasks—Tasks—Here users can enter task information, including the duration of the task (manpower days and toolpower days). The user can also enter the minimum number of staff that should be present on each day. Finally, users can enter the types of skills which can perform the task and the tool types which are needed for the task. (FIG. 6)

7) Tasks—Sites—The user enters the sites at which the tasks take place, as well as general site information including closure dates and tenders (site operators) who must be present for any work done at the site. Finally, the user can display a dialog box where each individual task for that particular site is displayed and can be customized. (FIG. 7)

8) Assignment—Here, the user controls the criteria for the plan to be assigned. After adjusting the desired sliders, the user can push GO and instantly generate a cost estimate. (FIG. 8)

9) Reports—After perfecting the desired plan, the user can print out reports of the plan, both visually using Microsoft® Project, in a tabular fashion with Microsoft® Excel, or just view them with a text viewer. (FIG. 10—A sample GANTT chart from Microsoft Project of a generated assignment plan)

10) Modify—After a plan has been generated, there will invariably be variations, like if a worker becomes sick. The Modify screen allows users to change the program dates, etc. around after work has started. (FIG. 9)

As mentioned above, the system handles four main dimensions: staff, equipment, tasks, and sites. Each contains pointer references to the others. For example, in addition to containing basic information, the staff data type contains information on which tasks at which sites on which days the staff is working. This is accomplished by a series of classes and pointers to the other various classes, forming an interlocking web. (FIG. 11)

Internal Engine

At a basic level, the system uses a system of weighted averages based on the user's preferences to determine the best staff to fit each task. First, it assembles a list of staff which can perform the task (based on skills). Then, it gives each a score. FIG. 12 shows pseudo-code that illustrates this concept.

After executing the code, the function will return a list of staff qualified to perform the task, in the optimal order. The program will then cycle through all the days where the task is scheduled to occur, going down the list from most desirable staff member to least desirable staff member for the task.

FIG. 13 shows the code for the classes used throughout the system. It illustrates how these classes each have pointer references to each other. The chief benefit of this is that it is extremely easy to access any sort of data from anywhere. For example, it would be just as easy to print a report of the days each staff works as it would be to print a list of tasks at a site or a list of staff assigned to a particular task. The downside is that it takes space, but the pointer references are all integers in size, so the net change in space is not terribly large.

Thus, there are significant speed and efficiency benefits in creating cross-linkages between the resource. It also speeds up cost-calculation and plan generation in general. Other important features of this engine include the site/sub-site and group/subgroup feature. Thus, the program can process certain staff that are only allowed to work at certain sites.

Time Handling

Within the program there are three different types of time handling that users can choose: to finish all tasks as fast as possible, to use the optimum plan, and to spread work throughout the allotted time. There are benefits and downfalls to each process. This section explains each and how they are implemented in the program.

1) Finish Tasks Quickly—This method is applicable when the user wants to finish all tasks as soon as possible, if there may be possible delays in the future that would disrupt work. It increases the cost because less desirable workers are also used in an attempt to finish work quickly. The software attempts to allocate as many personnel as there are available on each day. It goes through each day in this manner until the task is completed. So, if the task required five manpower days and there were six personnel available on day one, the task would finish on day one, using five of the six.

2) Optimum Plan—This method is applicable under normal situations, where the user will want to try and follow the criteria. It creates a weighted average system and ranks the personnel available for the task using this system. It then tries to use only the best person, scanning all of the allotted time. If the task cannot be completed with only the best staff member, the program tries with the second best, etc. Generally, this will produce the plan that fits the user's criteria the best. If equal work-distribution is the dominant criteria, the program will attempt to use those with the least amount of work first.

3) Spread Work Throughout—This method is applicable when cost is not a large issue, but the user would like to keep all staff fairly busy throughout the given time. It scans all days, using the best worker for each day. Thus, there is always someone working on each day unless either there is absolutely no one available or the work has been completed.

Features/Constraints Currently Implemented

These constraints and options help the user custom-tailor the plan to his/her needs. Of course, it makes sense that the more options are available the more the plan will fit the user's requirements.

1) Workdays of Week—Though many firms do indeed work from Monday to Friday, this does not give users the flexibility they require. For example, if a project is scheduled to occur on weekends, a program that can only handle five day weeks will fail. Thus, this program increases flexibility by allowing users to specify which days of the week would be work days.

2) Overtime Days—Whenever allocating resources, the problem of scarcity will come up. What will happen if there just aren't enough resources to cover the task? This is where OT days comes in. For example, if in general the project runs Monday through Friday, Saturday and Sunday would be overtime days. Thus, even if the entire staff is busy during the weekday, tasks that have deadlines on Monday can still be completed by allocating staff on overtime days. For this purpose, users can enter a staff overtime rate to calculate this portion of the cost.

3) Contractors—In some dire cases, even overtime working cannot cover the entire task. In this case, contractors must be used. This may be the case if the time allotted just isn't long enough, or if none of the staff hired have the skills required. Each different skill can have a different contractor cost, which will be calculated into the total cost.

4) Rental Tools—These are similar to contractors, except they are applied to tools5) Min Staff/Day—Occasionally there are some tasks that require more than one staff working per day. For example, if operating a crane is a two person job, then there must be at least two people working on the task on all workdays.

6) Site Tenders—Site Tenders, or supervisors, must be present at any work done on the site. Thus, preferably, the site tender him/herself does the work required, to save costs.

7) Staff and Equipment Absences/Site Closures—Occasionally, of course, people will be sick or go on vacation. Tools will need repairs, and sites will be closed down due to various reasons such as migratory season. Users can input the start and end date of the absence as well as a reason. Finally, they can disable staff, tools, or sites, so that they will not be used in plan assignment.

Afterword

It should be noted that the four dimensions here—Staff, Tools, Tasks and Sites can be substituted by any other variables, as long as they keep their relationship as described in FIG. 12. Thus, the program can be adapted to allocate textbooks and workbooks allocated to children in different classrooms, or guards and vehicles to various duties at lookout points.

### REFERENCES

Blanchard, Benjamin and Fabrycky, W. J. Systems Engineering and Analysis. New Jersey: Prentice Hall, 1990

de Neufville, Richard. Applied Systems Analysis: Engineering Planning and Technology Management. New York: Mc-Graw Hill, 1990

Graham, Robert J. Creating an Environment for Successful Projects. San Francisco: Jossey-Bass. 1997

Spinner, M. Elements of Project Management: Plan, Schedule, and Control. New Jersey: Prentice-Hall, 1981

1. A system which is able to take a list of staff with certain abilities (skills) and assign them to tasks which require such skills. It uses weighted averages to calculate the best staff for the position. The system includes an easy-to-use user interface.

2. A method as recited in claim 1, where the tasks to schedule have constraints placed upon them such as a fixed starting or ending date, and a minimum amount of staff working per day

3. A method as recited in claim 2, where equipment (such as bulldozers) are also required by tasks, which adds additional variables such as availability of equipment, availability of equipment operators, and repair/maintenance as well as criteria for arrangement such as tool cost and preferences

4. A method as recited in claim 3 where each task takes place at several different locations, which adds more restrictions such as site supervisors who must be present during any job performed at the site, and there may be periods where the site is closed

5. A method as recited in claim 4 where overtime hours, weekday hours, rental tools and contractors can be used to provide the user with a more realistic plan that accounts for staff shortages and more

6. A system as recited in claim 5 which goes beyond merely accomplishing each task in the allotted time span and includes:
Criteria to further customize the assignment of staff, such as taking into account staff cost, equal (or unequal) distribution of labor, rushing or spreading work evenly throughout the time, and user-defined preferences such as experience level
A weighing system to allow users to specify how important each criterion will be relative to the other criteria, enabling users not only to specify that criterion A will be more important than criterion B, but exactly how much more important as well
A user-interface which allows easy adjustments of aforementioned criteria and weighing
Utilizing of faster sorting methods to quickly large amounts of data without significant loss to the total computation speed, allowing user to simultaneously see the effects on the total project cost while adjusting the various criteria
